(19) United States
(12) Patent Application Publication
(10) Pub. No.: US 2023/0147135 A1
(43) Pub. Date: May 11, 2023

(54) DEAD-LOCKING CONTROL MECHANISM FOR DOOR LOCK

(71) Applicant: DEZHAO XIANG, SHENZHEN (CN)

(72) Inventor: DEZHAO XIANG, SHENZHEN (CN)

(21) Appl. No.: 18/150,176

(22) Filed: Jan. 4, 2023

Related U.S. Application Data
(63) Continuation-in-part of application No. 17/000,382, filed on Aug. 24, 2020.

(51) Int. Cl. E05B 13/00; E05B 63/00

(52) U.S. Cl. CPC E05B 13/004; E05B 63/0017

(57) ABSTRACT

A dead-locking control mechanism for a door lock includes: a lock body; a fixing assembly; a rotatable spindle assembly having a first end rotatably connected with the fixing assembly and a second end in torque transmission connection with the bolt of the lock body, such that the bolt is drivable to extend beyond or retract into the fixed object; and a dead-locking control assembly including a stopping member arranged at the first end of the spindle assembly. The stopping member is movable between first and second positions relative to the spindle assembly, wherein in the first position, a first end of the stopping member is engaged with the fixing assembly and locked relative to the fixing assembly to thereby prevent the spindle assembly from rotating, and wherein in the second position, the stopping member is released from fixing assembly and thus the spindle assembly is capable of rotation freely.

### CROSS-REFERENCE TO RELATED APPLICATIONS

This application is a Continuation-in-Part Application of my application U.S. Ser. No. 17/000382, filed on Aug. 24, 2020, entitled “Dead-locking control mechanism for door lock” the entire contents of which are hereby incorporated by reference.

### TECHNICAL FIELD

The present disclosure relates to the field of locks, and in particular, to a dead-locking control mechanism for an indoor door lock.

### BACKGROUND

Door lock is a device for locking the door so as to prevent others from opening the door. There are many types of door locks, and the requirements on the door locks are different in various occasions.

Typically, the dead-locking knob for the indoor door lock is not configured to control the latch bolt. Rather, an additional dead bolt is provided which is controlled by the dead-locking knob. On the one hand, the cost is increased; and on the other hand, the volume and area of the door lock are increased.

To solve the above problem, the present discloses provides a dead-locking control mechanism for a door lock.

### SUMMARY

### (1) Objective of the Present Disclosure

In order to solve the technical problems existing in the prior art, the present disclosure provides a dead-locking control mechanism for a door lock. The dead-locking control mechanism controls a spindle assembly to continue to move by a dead-locking control assembly, thereby controlling a bolt of a linkage lock body to extend and retract to replace an existing dead-locking knob.

### (2) Technical Solution

To solve the above problem, the present disclosure provides a dead-locking control mechanism for a door lock, comprising:

a lock body comprising a retractable bolt connectable to a fixed object;

a fixing assembly spaced apart from the lock body and being stationary relative to the fixed object;

a rotatable spindle assembly having a first end and a second end opposite to each other, the first end being extending through the fixing assembly, and the second end being in torque transmission connection with the retractable bolt of the lock body, such that the bolt is drivable by rotation of the spindle assembly to slide to extend beyond or retract into the fixed object; and

a dead-locking control assembly, comprising a stopping member arranged and exposed at the first end of the spindle assembly,

wherein the stopping member is movable between a first position and a second position relative to the spindle assembly, wherein in the first position, a first end of the stopping member is engaged with the fixing assembly and locked relative to the fixing assembly to thereby prevent the first end of the spindle assembly from rotating relative to the fixing assembly, and wherein in the second position, the stopping member is released from fixing assembly and thus the spindle assembly is capable of rotating freely.

In some embodiments, a second end of the stopping member opposite to the first end includes an operating portion, which is accessible and operatable from outside.

In some embodiments, a second end of the stopping member opposite to the first end thereof at least partially protrudes out from the spindle assembly.

In some embodiments, the fixing assembly defines a groove engagable with the first end of the stopping member.

In some embodiments, the fixing assembly defines a plurality of grooves arranged spaced apart from each other along a circumferential direction of the fixing assembly.

In some embodiments, the fixing assembly defines three grooves, which are arranged spaced apart from each other along a circumferential direction of the fixing assembly at an included angle of 90 degrees between two adjacent grooves.

In some embodiments, the spindle assembly includes a spindle and a spindle driving member arranged at a first end of the spindle, wherein the dead-locking control assembly is at least partially arranged at a radial outer side of the spindle driving member.

In some embodiments, the dead-locking control assembly further comprises an abutting member and a spring, wherein the abutting member is fixedly arranged relative to the spindle driving member, and the spring is arranged between the abutting member and the stopping member.

In some embodiments, the spindle driving member is provided with a sliding hole extending there through from an radially inner side to an radially outer side, a radial outer portion of the stopping member is received in the sliding hole, and wherein the spring has a first end connected with the stopping member and a second end abutting against the abutting member.

In some embodiments, the stopping member includes a positioning groove, wherein the first end of the spring is received within the positioning groove and held therein.

In some embodiments, the radial outer portion of the stopping member is formed as a protruding button portion, wherein the button portion at least partially passes through and extends out of the sliding hole.

In some embodiments, the positioning groove is at least partially extends into the button portion.

In some embodiments, the stopping member includes a main body from which the button portion protrudes, and a positioning protrusion protruding from the main body, the positioning protrusion is engagable with the sliding hole to lock a movement of the stopping member along an axial direction of the spindle driving member.

In some embodiments, an edge of the positioning protrusion is connected with an edge of the button portion and forms a shape together with the edge of the button portion corresponding to a profile of the sliding hole, and wherein the edge of the positioning protrusion and the edge of the button portion have a chamfer.

In some embodiments, the sliding portion is formed as an elongated hole.

In some embodiments, the spindle driving member is provided with a sliding groove therein extending along an axial direction of the spindle driving member, and the main body is slidably restricted in the sliding groove.

In some embodiments, the fixing assembly includes at least one groove engagable with the main body.

The above technical solution of the present disclosure has the following technical effects:

The dead-locking control assembly is configured to stop the spindle assembly from continuing to move, thereby preventing a deadbolt from being driven by the spindle assembly to be unlocked or locked to achieve the purpose of indoor dead-locking. Meanwhile, the production cost and the volume of the door lock are reduced, and the single deadbolt is more reasonable.

### BRIEF DESCRIPTION OF THE DRAWINGS

FIG. 1 is a schematic view showing a structure of a dead-locking control mechanism for a door lock according to the present disclosure.

FIG. 2 is a schematic view of an internal structure of a spindle driving member in the dead-locking control mechanism for a door lock according to the present disclosure.

FIG. 3 is a schematic view of a side structure of a fixing assembly in the dead-locking control mechanism for a door lock according to the present disclosure.

FIG. 4 is an exploded schematic view of the dead-locking control mechanism for a door lock of FIG. 1, wherein the fixing assembly and the lock body are removed to show an internal structure.

FIG. 5 is another exploded schematic view of the dead-locking control mechanism for a door lock of FIG. 4.

FIG. 6 is another exploded schematic view of the dead-locking control mechanism for a door lock of FIG. 1.

FIG. 7 is another exploded schematic view of the dead-locking control mechanism for a door lock of FIG. 6.

FIG. 8 is a schematic view of a side structure of a fixing assembly of an alternative dead-locking control mechanism for a door lock according to the present disclosure.

### DESCRIPTION OF THE EMBODIMENTS

In order to make the objectives, technical solutions and advantages of the present disclosure clearer, the present disclosure will be further described in detail below with reference to specific embodiments and accompanying drawings. It should be understood that these descriptions are exemplary only and are not intended to limit the scope of the present disclosure. Also, in the following description, descriptions of well-known structures and techniques will be omitted to avoid unnecessarily obscuring the concepts of the present disclosure.

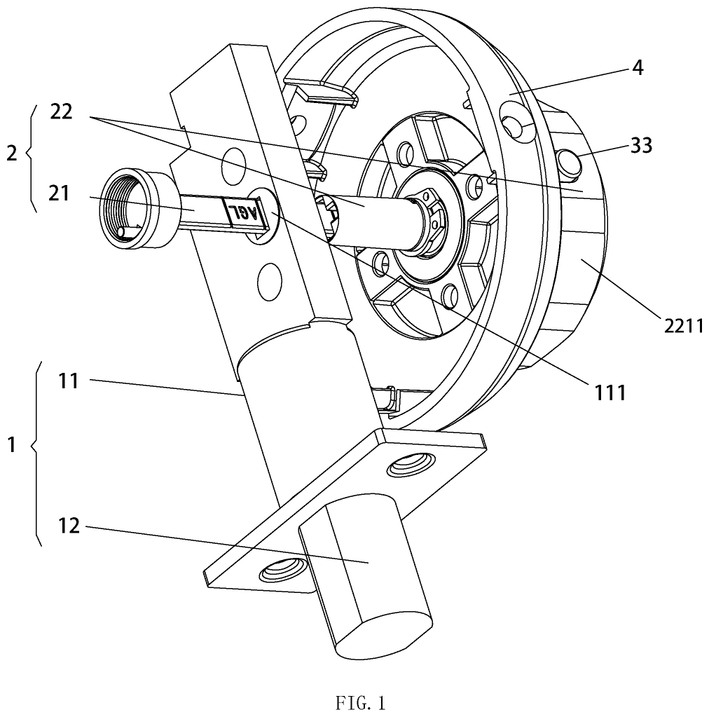

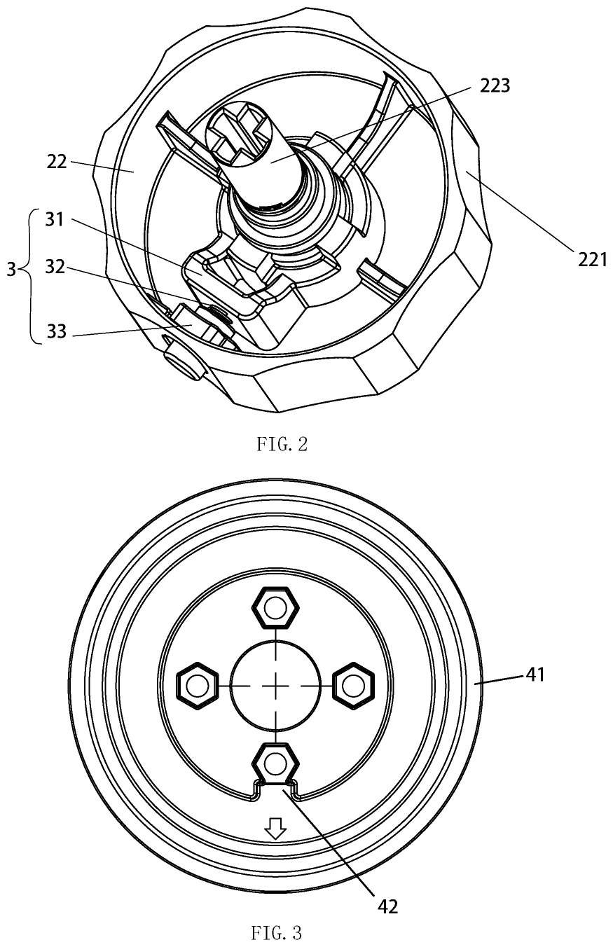

With reference to FIG. 1 to FIG. 3, a dead-locking control mechanism for a door lock includes: a lock body 1, a spindle assembly 2, a dead-locking control assembly 3, and a fixing assembly 4.

The lock body 1 includes a fixed body 11 configured to be stationarily fixed on an object to be locked, and further includes a bolt 12 which is slidably connected to the fixed body 11. Upon driven, the bolt 12 can extend beyond the fixed body 11 towards a lock hole (not shown) of an external fixed object, or retract from the lock hole towards the fixed body 11. The bolt 12 is mateable with the lock hole of the external fixed object. The bolt 12 can extend into the lock hole after moving towards the lock hole, thereby locking the object to be locked relative to the fixed object. In this embodiment, the bolt 12 is slidably received in the fixed body, and one end of the bolt 12 which is configured to be engaged with the lock hole can extend out of the fixed body 11 or retract into the fixed body 11. The object to be locked may be a door, a window or the like; and correspondingly the fixed object may be a door frame, a window frame or the like, or may be another door or window.

The spindle assembly 2 includes a spindle 21 and a spindle driving member 22. In this embodiment, the spindle 21 is substantially in a shape of an elongated sheet, and a first end of the spindle 21 along a longitudinal direction thereof is in torque-transmission connection with the lock body 1. Specifically, the spindle 21 is at least partially connected with the fixed body 11 in a form-fit manner, so as to drive the bolt 12 to move towards or away from the lock hole. Optionally, the fixed body 11 includes a driving mechanism 111 therein for driving the bolt 12 to extend out or retract therein. The spindle 21 is connected with the driving mechanism 111 in a form-fit manner, and the driving mechanism 111 may be in torque-transmission connection with the bolt 12, for example, through a rack and pinion engaged with each other, such that the bolt 12 can be driven to extend out or retract in by rotating the spindle 21 through the driving mechanism 111. Optionally, a second end of the spindle 21 may be in torque-transmission connection with the spindle driving member 22 for receiving an external driving force which is configured to drive the spindle assembly 2 to operate. In particular, the spindle driving member 22 may include a knob portion 221 for receiving the external driving force and a spindle connecting portion 223 in torque-transmission connection with the spindle 21.

The dead-locking control assembly 3 is movably connected to the spindle assembly 2, and configured to lock the spindle assembly 2 to prevent it from rotating or release the spindle assembly 2 to allow it to rotate.

The fixing assembly 4 is stationary relative to the fixed body 11. The fixing assembly 4 may be fixed on the object to be locked, for example, a door or a window. The spindle assembly 2 is rotatably connected with the fixing assembly 4. The spindle assembly 2 extends through the fixing assembly 4, with one end of the spindle assembly 2 located an outer side of the fixing assembly 4 and the other end of the spindle assembly 2 located at an inner side of the fixing assembly 4. Specifically, the knob portion 221 is located at the outer side of the fixing assembly 4, the spindle 21 is located at the inner side of the fixing assembly 4, and the spindle connecting portion 223 extends through the fixing assembly 4 to connect with the spindle 21. Alternatively, the spindle 21 may extend through the fixing assembly 4 from the inner side thereof to the outer side thereof to connect with the spindle connecting portion 223. The fixing assembly 4 is connectable with the dead-locking control assembly 3.

The dead-locking control assembly 3 is arranged at one end of the spindle assembly 2 where the spindle driving member 22 locates, and the dead-locking control assembly 3 can be driven by an external force to enable the dead-locking control assembly 3 to be connected with or separated from the fixing assembly 4, such that the spindle assembly 2 is prevented from continuing to move when the dead-locking control assembly 3 is connected with the fixing assembly 4, and the restriction of the movement of the spindle assembly 2 is released when the dead-locking control assembly 3 is separated from the fixing assembly 4.

Optionally, the dead-locking control assembly 3 may have a structure selected from any one of the following: a button plug type structure, a button pop-up type structure, a level type structure, a plug-pin type structure, a chain type structure, a stop opening type structure, a thimble type structure, a gear type structure and a magnetic valve type structure.

Optionally, the dead-locking control assembly 3 may have a shape selected from any one of the following: a square shape, a round shape, a conical shape, a trapezoidal shape, a rod shape, a spherical shape, a needle shape, a triangular shape and a column shape.

Optionally, the driving mode of the dead-locking control mechanism 3 may be selected from any one of the following: a push-button type, a sliding type, a bouncing type, a prizing type, a pushing type, a pulling type, a rotating type, a toggling type and a tooth shifting type.

Optionally, the spindle 21 of the spindle assembly 2 may be used alone, or one end of the spindle 21 may be in in torque-transmission connection with the spindle driving member 22; and one portion of the spindle driving member 22 passes through the fixing assembly 4 and is in torque-transmission connection with the spindle 21. The spindle driving member 22 is arranged on one side away from the lock body 11.

Optionally, the other end of the spindle 21 of the spindle assembly 2 passes through the lock body 11 and is in torque-transmission connection with the bolt 12, thereby controlling the bolt 12 to extend or retract.

Optionally, the fixing assembly 4 may be an object fixedly mounted on the door, or an external object fixedly connected with the lock body.

Optionally, the dead-locking control assembly 3 includes a stopping member 33, and the fixing assembly 4 includes a groove 42. By driving the stopping member 33, the stopping member 33 may be engaged with or separated from the groove 42. When the stopping member 33 is engaged with the groove 42, the spindle assembly 2 is prevented from rotating. When the stopping member 42 is separated from the groove 42, the restriction of the movement of the spindle assembly 2 is released.

With reference to FIG. 1 to FIG. 3, in an optional embodiment, the knob portion 221 is substantially of a column shape, and is opened at an axial end to form a hollow interior space. The knob portion 221 includes an end wall and a side wall extending from the periphery of the end wall. A radially outer periphery of the side wall of the knob portion 221 may be further provided with a concave-convex portion 2211 to facilitate a user to grasp and rotate. The dead-locking control assembly 3 includes an abutting member 31, a spring 32 and the stopping member 33. The abutting member 31 is at least partially arranged in the interior space of the knob portion 221, and is fixedly connected to the knob portion 221 through, for example, form-fitting.

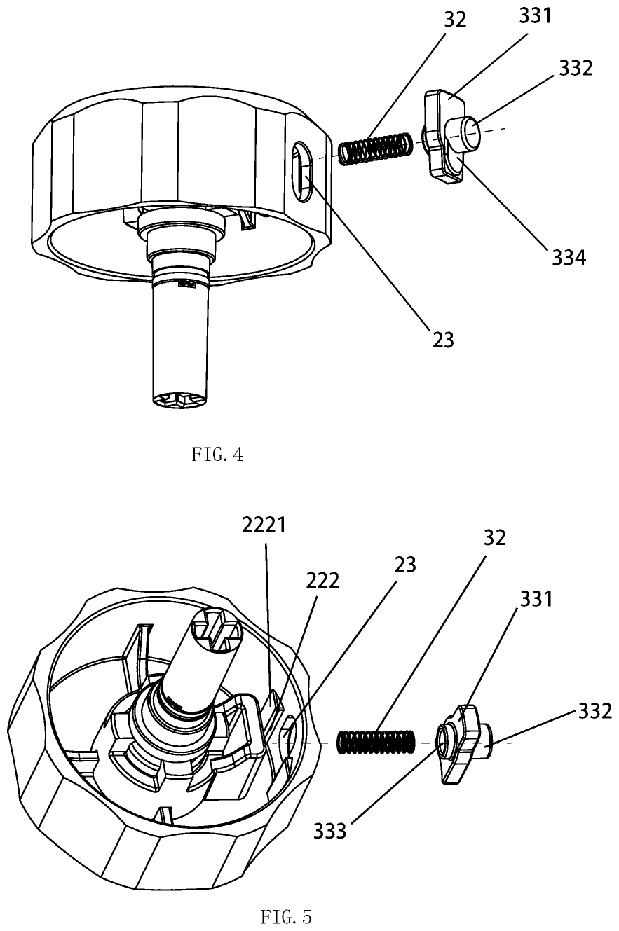

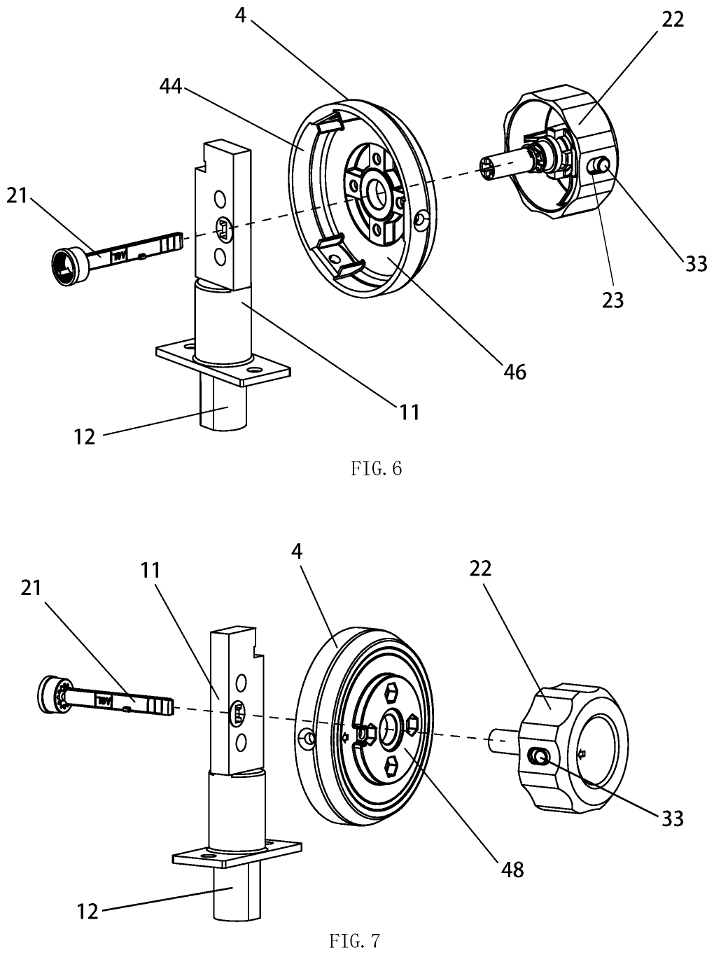

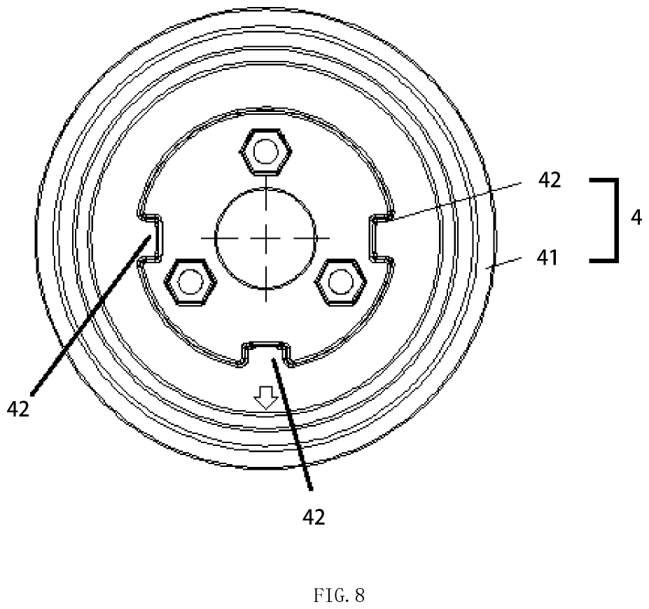

In addition, with reference to FIG. 4 and FIG. 5, a circumferentially side wall of the knob portion 221 is provided with a sliding hole 23. The stopping member 33 is at least partially arranged within the interior space of the knob portion 221 and slidably along an axial direction of the knob portion 221, with a portion thereof being engaged in the sliding hole 23. Specifically, the stopping member 33 includes a main body 331, a button portion 332 protruding from a first side surface of the main body 331, and a positioning groove 333 disposed on a second side of the main body 331 away from the button portion 332. Preferably, the positioning groove 333 at least partially extends into the button portion 332.

The main body 331 of the stopping member 33 is arranged in the interior space of the knob portion 221, and the knob portion 221 is provided with a sliding groove 222 therein extending along the axial direction of the knob portion 221 corresponding to the main body 331. The sliding groove 222 communicates with the sliding hole 23. In this embodiment, the sliding groove 222 is defined by the opposite surfaces of two protrusions 2221 arranged spaced from each other along a circumferential direction of the knob portion 221. Those two protrusions 2221 protrude from an inner wall of the spindle driving member 22 along a radial direction towards the center of the spindle driving member 22. In this embodiment, the protrusions 2221 extend from the inner surface of the side wall of the knob portion 221. Preferably, each protrusion 2221 has a wedge shape, with a thickness measured along a thickness direction of the side wall of the knob portion 221 gradually increasing from an end away from the other protrusion 2221 towards another end facing the other protrusion 2221. Such configuration can increase the strength of the protrusion 2221 while reducing material and thus the weight of the knot portion 221. Alternatively, the protrusions 2221 may extend from the inner surface of the end wall of the knob portion 221.

The main body 331 is substantially in a shape of a plate, which is slidably positioned in the sliding groove 222 defined between the two protrusions 2221, and thus the main body 331 can be restricted and guided by the sliding groove 222. The sliding hole 23 is an elongated hole with a long axis extending along the axial direction of the knob portion 221. For example, the sliding hole 23 has an oval shape in this embodiment. That is, the length of the sliding hole 23 along the axial direction of the knob portion 221 is greater than a width of the sliding hole 23 along the circumferential direction. A distal end of the button portion 332 away from the main body 331 extends into the sliding hole 23, and preferably protrudes out from the sliding hole 23 from the interior to the exterior of the knob portion 221. Two ends of the sliding hole 23 along the long axis direction limit a movement range of the button portion 332 along the axial direction of the knob portion 221.

A side surface of the main body 331 where the button portion 332 is located further includes a positioning protrusion 334. The positioning protrusion 334 protrudes from the surface of the main body 331 by a height much less than that of the button portion 332. The positioning protrusion 334 can extend into or disengaged from the sliding hole 23. Preferably, an edge of the positioning protrusion adjoins with an edge of the button portion 332 and they together forms a shape corresponding to a profile of the sliding hole 23, such that the positioning protrusion 331 and the button portion 332 can be positioned in the sliding hole 23 in a form-fit manner without movement. However, when the button portion 332 is pressed to move radially inwardly, the positioning protrusion 331 is disengaged from sliding hole 23 and the stopping member 33 can be moved along the axial direction of the sliding hole 23.

In this embodiment, the edge of the positioning protrusion 331 and the button portion 332 are combined to form an oval shape corresponding to the sliding hole 23. Preferably, the edge of the positioning protrusion 331 preferably forms a chamfer, such that the button portion 332 can be pressed to move the stopping member 33 relatively smoothly away from an initial position, and when the stopping member 33 is moved back to the initial position, the positioning protrusion 331 may be in contact with the edge of the sliding hole 23 through the chamfer, and automatically slides back to the initial position and remains there under the push of the spring 32.

After moving axially along the sliding hole 23, one axial end of the main body 331 can extend towards the fixing assembly 4 to be engaged with the groove 42 of the fixing assembly. As shown in FIG. 3, the fixing assembly 4 has a circular end plate 44 and an annular sidewall 46 extending from a periphery of the end plate 44. The end plate 44 has a top surface facing away from the direction towards which the sidewall extends. A boss 48 is formed on the top surface of the end plate 44 and protrudes from a central portion thereof along the axial direction. The groove 42 is provided in the boss. Preferably, the groove 42 is recessed from a distal portion of the boss 48 along the axial direction of the fixing assembly. In this embodiment, only one groove 42 is provided. Alternatively, in other embodiments, for example, as shown in FIG. 8, a plurality of grooves 42 may be provided, which are distributed along a circumferential direction.

The spring 32 is arranged within the internal space of the knob portion 221, one end of the spring 32 is received in the positioning groove 333 of the stopping member 33 and is fixedly connected with the stopping member 33, and the other end of the spring 32 abuts against the abutting member 31. The spring 32 is positioned within the positioning groove 333, such that the spring 32 can slide along the axial direction of the knob portion 221 together with the stopping member 33. Meanwhile, when the stopping member 33 is pushed radially inwardly towards an inner side of the knob portion 221, the spring 32 is compressed, thereby providing a spring force for restoring the stopping member 33.

In an alternative embodiment, with reference to FIG. 8, the fixing assembly 4 includes three grooves 42, and the three grooves 42 are arranged spaced apart in sequence along the circumferential direction at an include angle of 90 degrees between two adjacent grooves. The three grooves 42 are all engagable with the stopping member 33. Thus, the knob assembly 2 can be locked in multiple positions, with a locking state of the spindle 21 corresponding to the knob assembly 2 being maintained. For example, the knob assembly 2 may be locked in a first position in the locking state in which the bolt is extended out, such that the unlocking cannot be performed even if the user attempts to rotate the knob portion 221; or the knob assembly 2 can be locked in a second position of an unlocking state in which the bolt is retracted in, such that the object to be locked maintains the released unlocking state relative to the external fixed object, and the operator can move the door freely without any operation to the knob portion 221.

In the present disclosure, by pressing and moving the stopping member 33 to be engaged with the groove 42 inside the fixing assembly 4, the knob portion 221 is locked relative to the fixing assembly 4 by the stopping member 33, that is, the knob cannot be rotated any more, thereby preventing the spindle 21 from continuing to move, and further preventing the bolt from being unlocked or locked to achieve the purpose of indoor dead-locking. Meanwhile, the production cost is lowered, and the volume of the door lock is reduced.

It should be noted that, in this specification, relational terms such as first and second are only used to distinguish one entity or operation from another entity or operation, and do not necessarily require or imply that there is any actual relationship or order between these entities or operations. Furthermore, terms “include”, “comprise” or any other variations thereof are intended to encompass non-exclusive inclusion, such that a process, a method, an article or a device including a series of elements not only includes those elements, but also includes other elements that not explicitly listed, or also includes inherent elements of the process, the method, the article or the device.

Although embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is defined by the appended claims and their equivalents.

What is claimed is:

1. A dead-locking control mechanism for a door lock, comprising:
a lock body (1) comprising a retractable bolt (12) connectable to a fixed object;
a fixing assembly (4) spaced apart from the lock body (1) and being stationary relative to the fixed object;
a rotatable spindle assembly (2) having a first end and a second end opposite to each other, the first end being extending through the fixing assembly (4), and the second end being in torque transmission connection with the retractable bolt (12) of the lock body (1), such that the bolt (12) is drivable by rotation of the spindle assembly to slide to extend beyond or retract into the fixed object; and
a dead-locking control assembly (3), comprising a stopping member (33) arranged and exposed at the first end of the spindle assembly (2),
wherein the stopping member (33) is movable between a first position and a second position relative to the spindle assembly (2), wherein in the first position, a first end of the stopping member (33) is engaged with the fixing assembly (4) and locked relative to the fixing assembly (4) to thereby prevent the first end of the spindle assembly (2) from rotating relative to the fixing assembly (4), and wherein in the second position, the stopping member (33) is released from fixing assembly (4) and thus the spindle assembly (2) is capable of rotating freely.

2. The dead-locking control mechanism for the door lock according to claim 1, wherein a second end of the stopping member (33) opposite to the first end comprises an operating portion, which is accessible and operatable from outside.

3. The dead-locking control mechanism for the door lock according to claim 1, wherein a second end of the stopping member (33) opposite to the first end thereof at least partially protrudes out from the spindle assembly (2).

4. The dead-locking control mechanism for the door lock according to claim 1, wherein the fixing assembly (4) defines a groove (42) engagable with the first end of the stopping member (33).

5. The dead-locking control mechanism for the door lock according to claim 1, wherein the fixing assembly (4) comprises a plurality of grooves (42) arranged spaced apart from each other along a circumferential direction of the fixing assembly.

6. The dead-locking control mechanism for the door lock according to claim 5, wherein the fixing assembly (2) defines three grooves (42), which are arranged spaced apart from each other along a circumferential direction of the fixing assembly (4) at an included angle of 90 degrees between two adjacent grooves (42).

7. The dead-locking control mechanism for the door lock according to claim 1, wherein the spindle assembly (2) comprises a spindle (21) and a spindle driving member (22) arranged at a first end of the spindle (21), the spindle driving member (22) is at least partially located at an outer side of the fixing assembly, wherein the dead-locking control assembly (3) is at least partially arranged at a radial outer side of the spindle driving member (22).

8. The dead-locking control mechanism for the door lock according to claim 1, wherein the dead-locking control assembly (3) further comprises an abutting member (31) and a spring (32), wherein the abutting member (31) is fixedly arranged relative to the spindle driving member (22), and the spring (32) is arranged between the abutting member (31) and the stopping member (33).

9. The dead-locking control mechanism for the door lock according to claim 7, wherein the spindle driving member (22) is provided with a sliding hole (23) extending there through from an radially inner side to an radially outer side, a radial outer portion of the stopping member is received in the sliding hole (23), and wherein the spring has a first end connected with the stopping member (33) and a second end abutting against the abutting member (31).

10. The dead-locking control mechanism for the door lock according to claim 9, wherein the stopping member (33) comprises a positioning groove (333), wherein the first end of the spring is received within the positioning groove (333) and held therein.

11. The dead-locking control mechanism for the door lock according to claim 10, wherein the radial outer portion of the stopping member (33) is formed as a protruding button portion (332), wherein the button portion (332) at least partially passes through and extends out of the sliding hole (23).

12. The dead-locking control mechanism for the door lock according to claim 11, wherein the positioning groove (333) is at least partially extends into the button portion (332).

13. The dead-locking control mechanism for the door lock according to claim 11, wherein the stopping member (33) comprises a main body (331) from which the button portion (332) protrudes, and a positioning protrusion (334) protruding from the main body (331), the positioning protrusion (334) is engagable with the sliding hole (23) to lock a movement of the stopping member (33) along an axial direction of the spindle driving member (22).

14. The dead-locking control mechanism for the door lock according to claim 13, wherein an edge of the positioning protrusion (334) is connected with an edge of the button portion (332) and forms a shape together with the edge of the button portion (332) corresponding to a profile of the sliding hole (23), and wherein the edge of the positioning protrusion (334) and the edge of the button portion (332) have a chamfer.

15. The dead-locking control mechanism for the door lock according to claim 9, wherein the sliding portion (23) is formed as an elongated hole.

16. The dead-locking control mechanism for the door lock according to claim 13, wherein the spindle driving member (22) is provided with a sliding groove (222) therein extending along an axial direction of the spindle driving member (22), and the main body (331) is slidably restricted in the sliding groove (222).

17. The dead-locking control mechanism for the door lock according to claim 16, wherein the fixing assembly (4) comprises at least one groove (42) engagable with the main body (331).
